(19) United States
(12) Patent Application Publication
(10) Pub. No.: US 2008/0005684 A1
(43) Pub. Date: Jan. 3, 2008

(54) GRAPHICAL USER INTERFACE, SYSTEM AND METHOD FOR INDEPENDENT CONTROL OF DIFFERENT IMAGE TYPES

(75) Inventors: Matthew J. OCHS, Webster, NY (US); John A. MOORE, Webster, NY (US); Regina M. LOVERDE, Webster, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/427,605

(22) Filed: Jun. 29, 2006

(51) Int. Cl. G06F 9/00

(52) U.S. Cl. 715/764; 715/771; 715/810; 715/835

(57) ABSTRACT

Graphical user interface, system and method for independent control of image data including a plurality of image types may include a first set of icons that represent control functions that manipulate image data of a first image type and a second set of icons that represent control functions that manipulate image data of a second image type. The graphical user interface may enable, for example, and end user to control image data characteristics of a particular image type independently of controlling image data characteristics of a different image type within a page of a scanned document.

### BACKGROUND

The present disclosure relates to a graphical user interface, systems and methods for controlling image data. Specifically, the present disclosure relates to a graphical user interface, systems and methods for independently controlling different image types within a document.

Image data such as graphics, text, a halftone, continuous tone, or some other recognized image type is often stored in the form of multiple scanlines, each scanline comprising multiple pixels. The image data may be all one type, or some combination of image types. This image data is often manipulated by users of computer devices and corresponding components to adjust, for example, the image quality settings. Current graphical user interfaces allow for limited image adjustments that are applied equally to all the image data of the entire image.

It is known in the art to separate the image data of a page into areas or windows of similar image types. It is further known to separate the page of image data into two or more windows. For instance, image data may include a halftone picture with accompanying text describing the picture. A first window may include the halftone images and a second window may include the text. A scanner may segment the page containing the image data into various windows or areas of corresponding image data type. Processing of the page of image data may be carried out by tailoring the processing of each area of the image to the image data type being processed as indicated by the windows. Once the windows are identified the image quality settings defined by the user are applied to the page.

The user manipulates the image data by applying common settings to the document page or by manually defining image areas with a page and applying the desired settings to each area.

### SUMMARY

Current graphical user interfaces allow for limited image adjustments. For example, as shown in FIG. 6, a graphical user interface 90 has controls 92 for adjusting brightness, contrast, and sharpness in order to manipulate image data on a page 96 shown in a display screen 98. The image data may include a photo 93 of high frequency halftone content, an image 94 of low frequency halftone content, and text 95. However, when making any of the adjustments, the modifications are applied equally to all the image data 93, 94, 95 and are seen across the entire page 96. Thus, it is difficult to adjust settings for example, of only the image 94 of low frequency halftone content, not the text 95 in the image data describing the image 94, or the photo 93 of high frequency halftone content.

Currently however, the user only has two means of addressing this issue. First, the user chooses to manipulate only one image type for the whole document and apply common settings to the entire page. Second, the user manually defines the different image areas with a page and apply the desired settings to each area. The first option, however, does not adequately address the issue of accommodating different types of image areas within the page. The second options time consuming, cumbersome and laborious. This option involves acquiring a preview scan, selecting a “Manual Windows” feature on the GUS, drawing rectangular “boxes” around the content to be processed differently from the current image quality setting, changing the controls to the desired settings, then finally scanning the image with the new settings applied. This may be done on a scan-by-scan basis so a document with numerous pages would require this manual procedure to be done numerous times.

Exemplary graphical user interfaces, systems and methods overcome the deficiencies in the prior art. A graphical user interface, system or method may include sets of control icons that control different areas of a particular image type. For example, a set of control icons may independently adjust image quality characteristics such as brightness, contrast, and sharpness for photo/high frequency halftone content. A different set of control icons may adjust the image quality characteristics of brightness, contrast, and sharpness to different settings for low frequency halftone content.

Exemplary graphical user interfaces, systems and methods for independently controlling different image types may be incorporated in scanning devices and may comprise separating and keeping track of image data labeled as graphics, text, a halftone, continuous tone, or some other recognized image type. Such methods may also include classifying the image data within an area as a particular image type and recording document statistics regarding designated areas, non-designated areas and image type of each area.

To improve efficiency, area labels, or IDs, may be allocated on an ongoing basis during, for example, first level segmentation processing, while at the same time dynamically compiling window ID equivalence information. Once the image type for each area is known, further processing of the image data may be more optimally specified and performed.

Exemplary embodiments may automatically locate an area or window contained within a document. A window is defined herein as any non-background area, such as a photograph or halftone picture, but may also include text, background noise and white regions. Various embodiments described herein include two passes through the image data for segmentation.

During a first level segmentation of the image data, a classification module may classify pixels may as white, black, edge, edge-in-halftone, continuous tone (rough or smooth), and halftones over a range of frequencies. Concurrently, a window detection module may generate window-mask data, may collect document statistics and may develop an ID equivalence table, all to separate the desired windows from undesired regions.

During a second level segmentation of the image data, pixel tags may be modified by a merging module, replacing each pixel's first segmentation tag with a new tag indicating association with a window. These tags may be used to control downstream processing or interpretation of the image. The downstream processing may include a graphical user interface for independently controlling the different image types within a window or area.

Exemplary embodiments may provide there is provided a graphical user interface for manipulating image data including a plurality of image types, comprising: a first set of icons that represent control functions that manipulate image data of a first image type; and a second set of icons that represent control functions that manipulate image data of a second image type.

In various exemplary embodiments, the first set of icons differs from the second set of icons.

In various exemplary embodiments, the plurality of image types includes at least two of text, line art, low frequency halftone, high frequency halftone, photograph, continuous tone and pictorial.

In various exemplary embodiments, the control functions manipulate brightness, sharpness and contrast.

In various exemplary embodiments, each of the control icons comprises a slider.

In various exemplary embodiments, each set of icons manipulates the image data on a window-by-window basis.

In various exemplary embodiments, each set of icons automatically manipulates the image data according to the image data type.

In various exemplary embodiments each set of icons manipulates the image data according to user-defined manual initial settings.

In various exemplary embodiments, the user-defined manual initial settings are default settings.

In various exemplary embodiments, the default settings are used in automated handling of documents by a system.

In various exemplary embodiments, such a graphical user interface may be incorporated in a xerographical imaging device.

Exemplary embodiments may provide a system for manipulating scanned image data in an electronic device, comprising: a controller; a graphical user interface generating circuit, routine or application, wherein the graphical user interface includes a first set of icons that represent control functions that manipulate image data of a first image type; and a second set of icons that represent control functions that manipulate image data of a second image type.

In various exemplary embodiments, the controller manipulates the image data in accordance with settings of one of the sets of icons on a window-by-window basis.

In various exemplary embodiments, the controller automatically manipulates the image data according to image data type.

In various exemplary embodiments, the controller manipulates the image data type according to user-defined manual initial settings.

Exemplary embodiments may provide a method of manipulating scanned image data within a page, comprising: providing a first set of icons that represent control functions that manipulate image data of a first image type; providing a second set of icons that represent control functions that manipulate image data of a second image type; manipulating the first image type using the first set of icons; and manipulating the second image type using the second set of icons.

In various exemplary embodiments, the method includes manipulating the image data type on a window-by-window basis.

In various exemplary embodiments, the method includes automatically manipulating the image data according to image data type.

In various exemplary embodiments, the method includes manipulating image data according to user-defined manual initial settings.

In various exemplary embodiments, the method includes using the user-defined manual initial settings as default settings.

### BRIEF DESCRIPTION OF THE DRAWINGS

Various exemplary embodiments are described in detail, with reference to the following figures, wherein:

FIG. 1 shows a flowchart illustrating an exemplary two level segmentation windowing method for manipulating scanned image data.

FIG. 2 shows a block diagram of an exemplary two level segmentation windowing apparatus for manipulating scanned image data.

FIG. 3 shows an exemplary first level of segmentation.

FIG. 4 shows an exemplary second level of segmentation.

FIG. 5 shows an exemplary graphical user interface for independently controlling different image types.

FIG. 6 shows a related art graphical user interface.

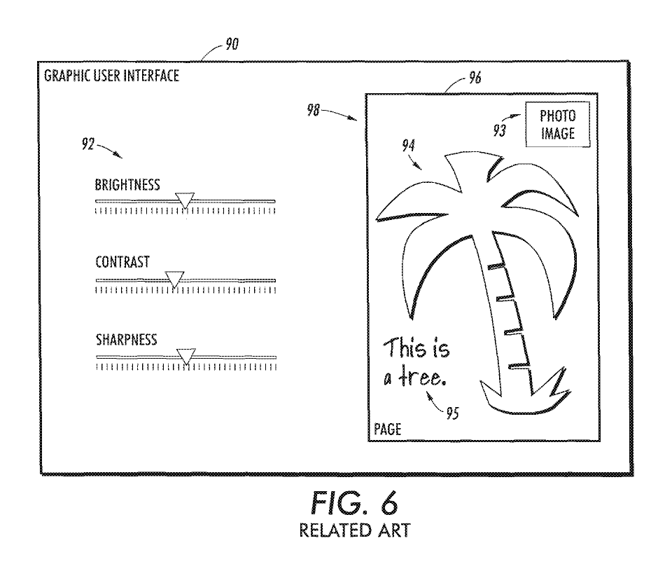

### DETAILED DESCRIPTION OF EMBODIMENTS

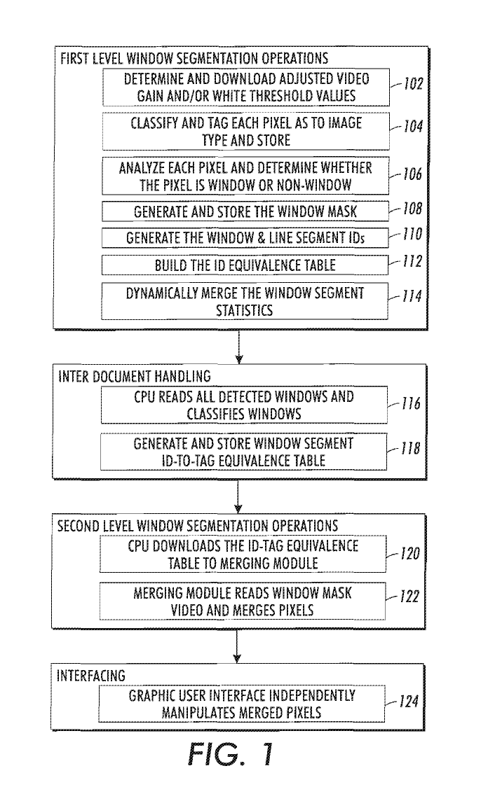

Apparatus, systems and methods for detecting windows of different image types may be incorporated within image scanners and other devices, and may include two levels of segmentation of the image data. FIG. 1 is a flowchart illustrating an exemplary two level segmentation windowing method that may enable independent control of windows of different image types in a downstream graphical user interface as described herein.

The exemplary method classifies each pixel as a particular image type, separates a page of image data into windows, collects document statistics on window areas and pixel image type and merges pixels appropriately based upon the collected statistics. Once the image type for each window is known, rendering, or other processing modules, not shown, may process the image data and do so more optimally than if the windowing and retagging were not performed.

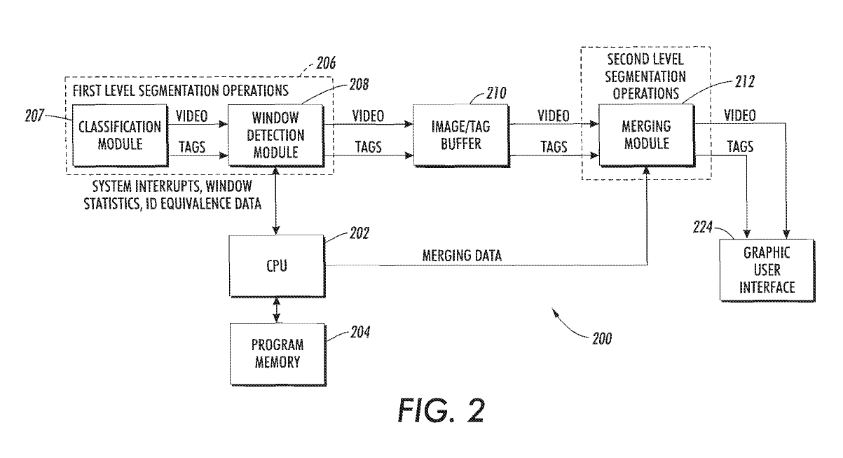

A block diagram of an exemplary two level segmentation windowing system 200 that may carry out the exemplary method is shown in FIG. 2. The exemplary system 200 may include a central processing unit (CPU) 202 in communication with a program memory 204, a first level segmentation operations module 206 including a classification module 207 and a window detection module 208, a RAM image buffer 210 and a retagging module 212. The CPU 202 may transmit and/or receive system interrupts, statistics, ID equivalence data and other data to/from the window detection module 208 and may transmit pixel merging data to the merging module 212. The first level segmentation and second level segmentation operations may be implemented in a variety of different hardware and software configurations, and the exemplary arrangement shown is non-limiting.

During the first level segmentation of the image data, pixels may be classified by the classification module 207 into, for example, graphics, text, a halftone, continuous tone, halftones over a range of frequencies, or some other recognized image type. Segmentation tags may be sent to the window detection module 208, which may use such tags and video to associate pixels with various windows and calculate various statistics for each window created.

Once sufficient statistics are collected, subsequent values may be determined and downloaded by the CPU 202, in step S102, to the window detection module 208. Using such subsequent values may improve the determination of whether a pixel is part of a window or is background. A detailed description of such control parameters is provided below.

As the image is scanned and stored, each pixel may, in step S104, be classified and tagged by the classification module 207 as being of a specific image type. In the exemplary embodiment shown in FIG. 1, the tags may also be stored. Alternatively, however, the tags may not be stored for later use, instead, they may be recreated at the beginning of the second level segmentation. In addition, step S104 may be performed concurrently with step S102. The order of the steps shown in FIG. 1 is exemplary only and is non-limiting.

An exemplary approach to pixel classification may include comparing the intensity of a pixel to the intensity of its surrounding neighboring pixels. A judgment may then be made as to whether the intensity of the pixel under examination is significantly different than the intensity of the surrounding pixels.

Subsequent to pixel classification, the window detection module 208 may, in step S106, analyze each pixel and may determine whether the pixel is window or background. Exemplary methods described herein may better define an outline around window objects by using at least one control parameter specific to determining whether pixels belong to window or background areas. Such control parameters may include a background gain parameter and/or a background white threshold parameter that may be predetermined or calculated and may be distinct from other gain and or white threshold levels used by the classification step S104 to classify a “white” pixel with a white tag.

in step S108, a window mask may be generated as the document is scanned and stored into image/tag buffer 10. The scanned image data may comprise multiple scanlines of pixel image data, each scanline typically including intensity information for each pixel within the scanline, and, if color, chroma information. Typical image types include graphics, text, white, black, edge, edge in halftone, continuous tone (rough or smooth), and halftones over a range of frequencies.

During step, S110, window and line segment IDs may be allocated as new widow segments are encountered. For example, both video and pixel tags may be used to identify those pixels within each scanline that are background and those pixels that belong to image-runs. The image type of each image run may then be determined based on the image type of the individual pixels. Such labels, or IDs, may be monotonically allocated as the image is processed.

In step S112, the window detection module 208 may dynamically compile window ID equivalence information and store such data in an ID equivalent table, for example. Also in step S112, decisions are made to discard windows and their associated statistics which have been completed without meeting minimum window requirements.

In step S114, at the end of the first level segmentation, an ID equivalence table and the collected statistics may be analyzed and processed by the window detection module 208. When processing is completed, the window detection module 208 may interrupt the CPU 202 to indicate that all the data is ready to be retrieved.

Typically, while a document image is initially scanned, the windowing apparatus performs its first level segmentation of the document image. In order to optimize processing speed, a subsequent image may be scanned and undergo first level segmentation windowing operations concurrent with the second level segmentation of the first image. However, after the first level segmentation operations finish, but before the second level segmentation begins, inter-document handling may be performed by the CPU 2)02.

In step S116, the CPU may read the statistics of all windows that have been kept and apply heuristic rules to classify the windows. Windows may be classified as one of various video types, or combinations of video types.

In addition, between the first and second pass operations, the CPU 202 may generate and store, in step S118, a window segment ID-to-Tag equivalence table.

During a second level segmentation, pixels may be tagged by the merging module 212. In step S120, the CPU 202 may download merging data comprising the window segment ID-to-Tag equivalence table to the merging module 212. Instep S122, the merging module 212 may read the window mask from the image buffer 210 and may merge pixels within all selected windows with an appropriate uniform tag based upon the ID-to-Tag equivalence table.

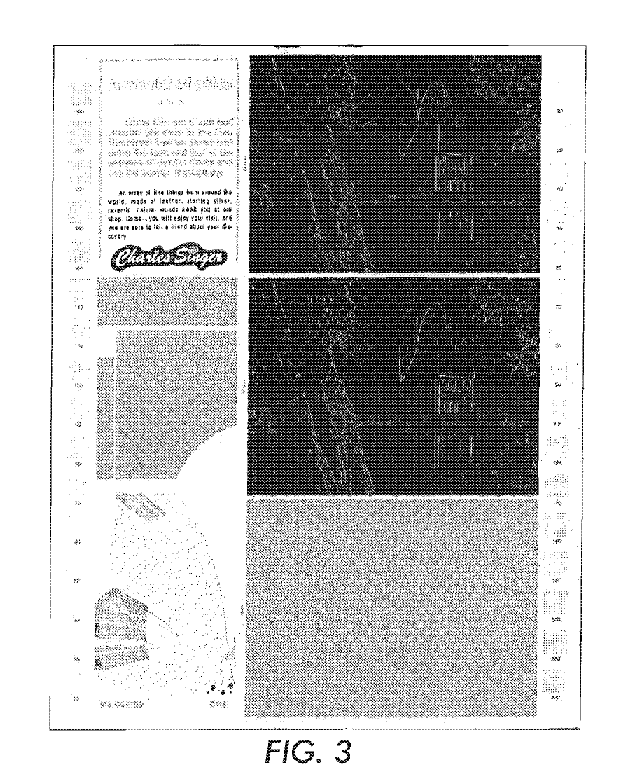

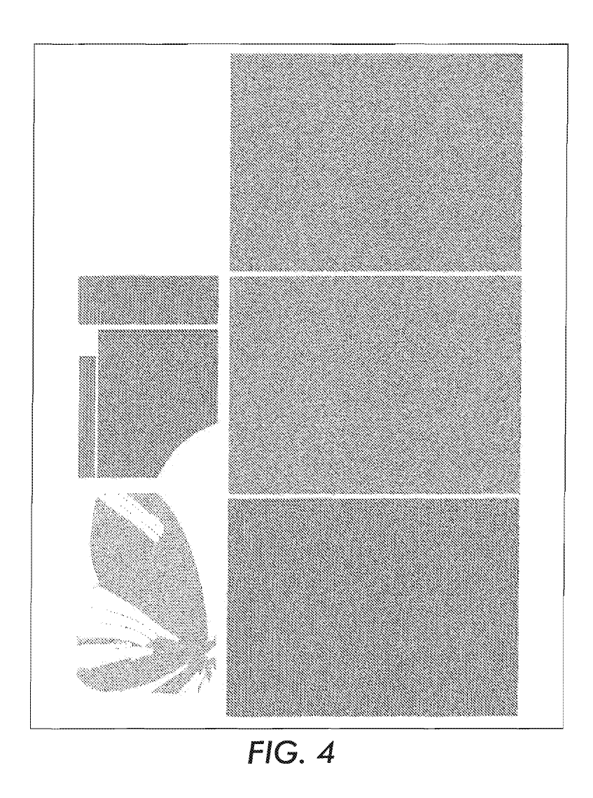

FIG. 3 illustrates an example of image data after first level segmentation during which a pixel by pixel classification is performed identifying areas of an image on a page as particular pixel type. The different illustrated shades may represent high frequency content, low frequency content, edges, text/line art, or another form of content. FIG. 4 illustrates an example of image data after second level segmentation during which pixels may be tagged and merged into windows of particular pixel types.

Referring back to FIG. 1, once each portion of the image data has been classified in a window according to image types, during interfacing a graphical user interface 224 may be used in step S124 to independently manipulate different image types of image data within a page.

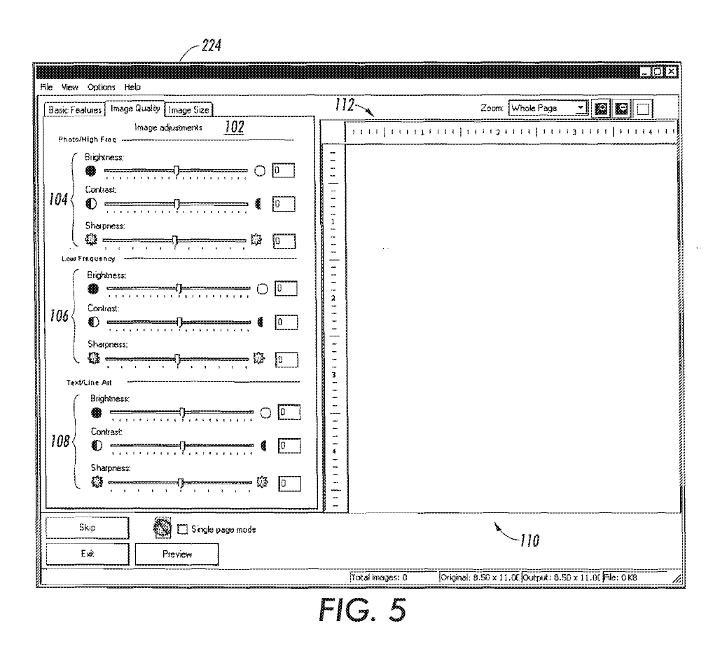

FIG. 5 shows an exemplary embodiment of a graphical user interface 224 for independently controlling different image types. The image types may be contained within a page 110 of a document. The graphical user interface 224 may comprise multiple sets of control icons 104, 106, 108. Each set of the multiple sets of control icons 104, 106, 108 may separately or in dependently adjust an image type of image data that differs from the image type corresponding to another set of control icons 104, 106, 108. For example, a set of control icons 104 may independently adjust image quality characteristics such as brightness, contrast, and sharpness for photo/high frequency halftone content. A different set of control icons 106 may adjust the image quality characteristics of brightness, contrast, and sharpness to different settings for low frequency halftone content.

Each set of the multiple sets of control icons 104, 106, 108 may separately or independently adjust image data based on different image types, on different windows or areas of a particular image type, or based on pixel type. The user may view the image data on a page 110 of a document shown in a display 112. Viewing the image data on a page 110 of a document shown in a display 112 allows the user to manipulate image type until the manipulation yields a desired result.

A first set of icons may differ from a second set of icons. For example, a set of control icons 104 may independently adjust image quality characteristics such as brightness, contrast, and sharpness. A second set of control icons 106 may independently adjust color tone, size or location. The second set of control icons 106, when different from the first set 104, may optionally control the image type of the first set 104, if specified by the user.

In the exemplary non-limiting embodiment, the sets of control icons 104, 106, 108 may independently manipulate image quality characteristics corresponding to different windows of a particular image type. The windows may have been defined by sedimentation and may include text, line art, low frequency halftone, high frequency halftone, and continuous tone photograph. The image type may be classified according to pixel type.

In another exemplary non-limiting embodiment, each of the control icons may comprise a slider. Each control icon may also comprise a button, lever, or other object for adjustment. For example, instead of sliders for brightness and contrast, a 5-bar graphic equalizer adjustment graphic may be used to adjust image quality. Further, each set of the multiple sets of control icons 104, 106, 108 may comprise an icon for adjustment different from another set of the multiple sets of control icons 104, 106, 108.

Each set of icons may optionally manipulate the image data on a window-by-window basis. Thus a set of the multiple sets of control icons 104, 106, 108 controlling, for example, photo/high frequency halftone content, may manipulate the image data for individual windows of photo/high frequency halftone content only.

Each set of icons may optionally manipulate the image data by automatically manipulating the image data according to the image data type. Some users may be happy with the resultant scan quality of all windows expect for photos. Thus, a set of the multiple sets of control icons 104, 106, 108 controlling, for example, photo/high frequency halftone content will automatically manipulate the image data for all windows of photo/high frequency halftone content.

In another exemplary non-limiting embodiment, each set of icons may optionally manipulate the image data according to user-defined manual initial settings. User-defined manual initial settings may include designating a set of the multiple sets of control icons 104, 106, 108 to control different image types according to areas, windows or image types selectively designated by the user. Different areas, windows or image types may be included to be controlled by the control icons while others are excluded. For example, there may be a general preference for solid, bold text in scans. In this case, the Brightness slider under Text/line Art may be preset to a darker setting automatically to ensure this quality occurs.

The user-defined manual initial settings may be entered by the user as default settings reiterated in future manipulations of image data. The default settings may also be used in automated handling of documents by a system. For example, the automated handling may vary according to image data requirements of varying systems. Thus, the defaults may be programmed into certain systems to meet the image data requirements of that particular system.

While the invention has been described in conjunction with exemplary embodiments, these embodiments should be viewed as illustrative, and not limiting. It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art and are also intended to be encompassed by the following claims.

What is claimed is:

1. A graphical user interface for manipulating image data including a plurality of image types, comprising:
a first set of icons that represent control functions that manipulate image data of a first image type; and
a second set of icons that represent control functions that manipulate image data of a second image type.

2. The graphical user interface according to claim 1, wherein the first set of icons differs from the second set of icons.

3. The graphical user interface according to claim 1, wherein the plurality of image types includes at least two of text, line art, low frequency halftone, high frequency halftone, photograph, continuous tone and pictorial.

4. The graphical user interface according to claim 1, wherein the control functions manipulate brightness, sharpness and contrast.

5. The graphical user interface according to claim 1, wherein each of the control icons comprises a slider.

6. The graphical user interface according to claim 1, wherein each set of icons manipulates the image data on a window-by-window basis.

7. The graphical user interface according to claim 1, wherein each set of icons automatically manipulates the image data according to the image data type.

8. The graphical user interface according to claim 1, wherein each set of icons manipulates the image data according to user-defined manual initial settings.

9. The graphical user interface according to claim 8, wherein the user-defined manual initial settings are default settings.

10. The graphical user interface according to claim 9, wherein the default settings are used in automated handling of documents by a system.

11. A xerographical imaging device comprising the graphical user interface of claim 1.

12. A system for manipulating scanned image data in an electronic device, comprising:
a controller;
a graphical user interface generating circuit, routine or application, wherein the graphical user interface includes:
a first set of icons that represent control functions that manipulate image data of a first image type; and
a second set of icons that represent control functions that manipulate image data of a second image type.

13. The system according to claim 12, wherein the controller manipulates the image data in accordance with settings of one of the sets of icons on a window-by-window basis.

14. The system according to claim 12, wherein the controller automatically manipulates the image data according to image data type.

15. The system according to claim 12, wherein the controller manipulates the image data type according to user-defined manual initial settings.

16. A method of manipulating scanned image data within a page, comprising:
providing a first set of icons that represent control functions that manipulate image data of a first image type;
providing a second set of icons that represent control functions that manipulate image data of a second image type;
manipulating the first image type using the first set of icons; and
manipulating the second image type using the second set of icons.

17. The method according to claim 16, further comprising manipulating the image data type on a window-by-window basis.

18. The method according to claim 16, further comprising automatically manipulating the image data according to image data type.

19. The method according to claim 16, further comprising manipulating image data according to user-defined manual initial settings.

20. The method according to claim 19, further comprising using the user-defined manual initial settings as default settings.
